(19) United States
(12) Patent Application Publication
(10) Pub. No.: US 2008/0025796 A1
(43) Pub. Date: Jan. 31, 2008

(54) ROOT IRRIGATION DEVICE

(76) Inventor: David M. Allen, Howell, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/768,018

(22) Filed: Jun. 25, 2007

Related U.S. Application Data
(60) Provisional application No. 60/816,438, filed on Jun. 26, 2006.

(51) Int. Cl. A01G 25/06; A01G 29/00

(52) U.S. Cl. 405/45; 239/44; 47/48.5

(57) ABSTRACT

An irrigation device for a root system of a plant includes a porous housing and plurality of deflectors within the housing to deflect water through the housing to surrounding soil. Water enters the device through natural and artificial surface water sources as well as from a water feed line. Deflectors span an internal cavity of the housing individually or collectively and thereby provide structural support to the sidewall of the housing. Deflectors that span and subdivide the internal cavity include at least one orifice for the passage of water and air. Interconnected deflectors simplify the installation and maintenance of the device. Deflectors interconnect with other deflectors directly in a self-supporting support structure or with a support structure having one or more support elements, Deflectors have varying deflecting surfaces including unitary deflecting surfaces and multifaceted deflecting surfaces having, among others, conical and pyramidal configurations.

### CROSS-REFERENCE TO RELATED APPLICATIONS

This application is a non-provisional of U.S. Provisional Application Ser. No. 60/816,438, entitled IRRIGATION CYLINDER, filed Jun. 26, 2006 and U.S. Provisional Application Ser. No. 60/918,976, entitled COMBINATION WATERING AND AERATING UNIT, filed Feb. 20, 2007, which are hereby incorporated by reference in their entirety.

### BACKGROUND

Traditionally, trees and shrubs have been irrigated using common sprinkler-type irrigation systems wherein water is distributed across and above the ground that surrounds the tree or shrub to be irrigated. This traditional method of irrigation was improved upon in recent years through the use of root irrigation devices that are buried underground proximate to the tree or shrub to be irrigated. These root irrigation devices may be provided with water from a water supply through conduits. In particular, U.S. Pat. No. 6,984,090 discloses such a root irrigation device.

Improved root irrigation devices include deflectors inside of the housing of the root irrigation device to deflect water to the outside of the housing and into the soil. Root irrigation devices that include deflectors disposed within a housing, as disclosed in my previous U.S. Pat. No. 6,984,090, are particularly effective in delivering water and nutrients to the root system of a plant.

It is desirable to improve the existing deflectors available in connection with root irrigation devices.

### SUMMARY

One exemplary embodiment provides an irrigation device having a porous housing configured to distribute water to surrounding soil. A plurality of interconnected deflectors disposed within the housing are configured to deflect water therethrough. Another embodiment relates to a generally conical deflector that directs water to the outside periphery of the housing and has at least one orifice therein to permit water to flow to lower portions of the housing.

### BRIEF DESCRIPTION OF THE DRAWINGS

While the claims are not limited to the illustrated embodiments, an appreciation of various aspects of the system is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

FIG. 1 is a sectional view of an exemplary embodiment of a root irrigation device attached to a water main and installed in the ground proximate to a plant and root system;

FIG. 2 is an enlarged view of one of the devices from FIG. 1;

FIG. 3 is a perspective view of one exemplary embodiment;

FIG. 4A is an exploded perspective view of one exemplary embodiment;

FIG. 4B is a second exploded perspective view of one exemplary embodiment;

FIG. 5 is a third exploded perspective view of one exemplary embodiment;

FIG. 6 is a sectional view of another exemplary embodiment of a support structure for use with the device;

FIG. 7 is a sectional view of an additional exemplary embodiment of an irrigation device;

FIG. 8A is a perspective view of exemplary embodiment of a deflector for use with the device;

FIG. 8B is a perspective view of another exemplary embodiment of a deflector for use with the device.

### DETAILED DESCRIPTION

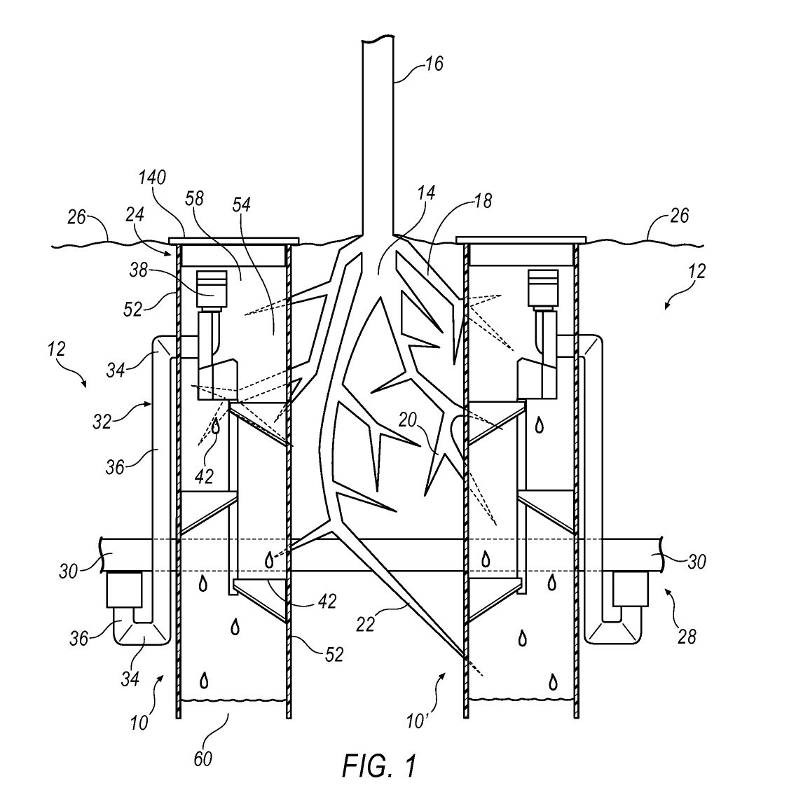

With references to FIG. 1 of the drawings, one possible root irrigation device according to the exemplary teachings of this disclosure is generally indicated by reference numeral 10. The device 10 is intended to be buried in a vertical orientation in the soil 12 near the root system 14 of a tree or plant 16. The root system 14 of a plant 16 typically includes roots 18 near the surface as well as roots 20, 22 at varying depths below the surface. When buried in a vertical orientation, the device 10 can be proximate to roots 18, 20, 22 at varying depths. The device 10 includes a housing 50 having a generally elongated cylindrical shape. The device 10 is placed in a hole 24 roughly corresponding to the outer dimensions of the housing 50. The housing 50 includes an open top 58 and an open bottom 60. Burying the device such that the open top 58 is approximately at ground level 26 can allow for the reception of both natural and artificial surface water sources.

The device 10 may be incorporated into an irrigation system 28 in combination with other root irrigation devices 10′ as well as surface watering devices (not shown). Such an irrigation system 28 would typically include a subsurface water main 30 or distribution line for delivering water to the various irrigation devices. While not depicted, various timers and moister sensors can be employed to control the timing and amount of water provided by the system.

A water feed line 32 can provide a direct source of water to the device. The water feed line, including various joint members 34, taps a water main 30 and enters the device 10. Elbow joints 34 according to U.S. Pat. No. 5,242,112 can provide an effective connection between the segments 36 of the water feed line 32. A water emitter 38 at the end 40 of the feed line regulates the flow rate and dispensing pattern of any supplied water 42. The water feed line 32 can pass through a sidewall 52 of the device to deliver water into the internal cavity 54. As described below, other embodiments provide a water feed line 32 that enters the housing through the open top 58 or open bottom 60. Water 42 dispensed from the emitter 38 falls by gravity onto a series of deflectors 70 that direct the water toward the porous sidewall 52. A support structure 10 can attach the deflectors 70 to one another. The deflectors 70 in combination with the support structure 110 span the internal cavity 54 and provide lateral support to the sidewall 52. The water feed line 32 and the sidewall 52 can cooperate to position the support structure 110 and the deflectors 70. An upper cap 140 provides structural integrity to the sidewall 52 and allows for the entry of surface water into the housing 50 while blocking the entry of large debris.

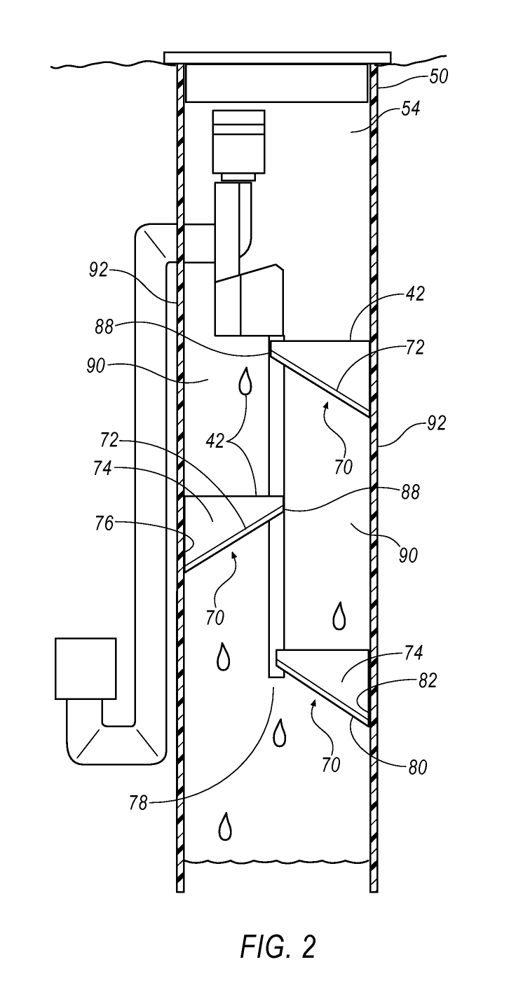

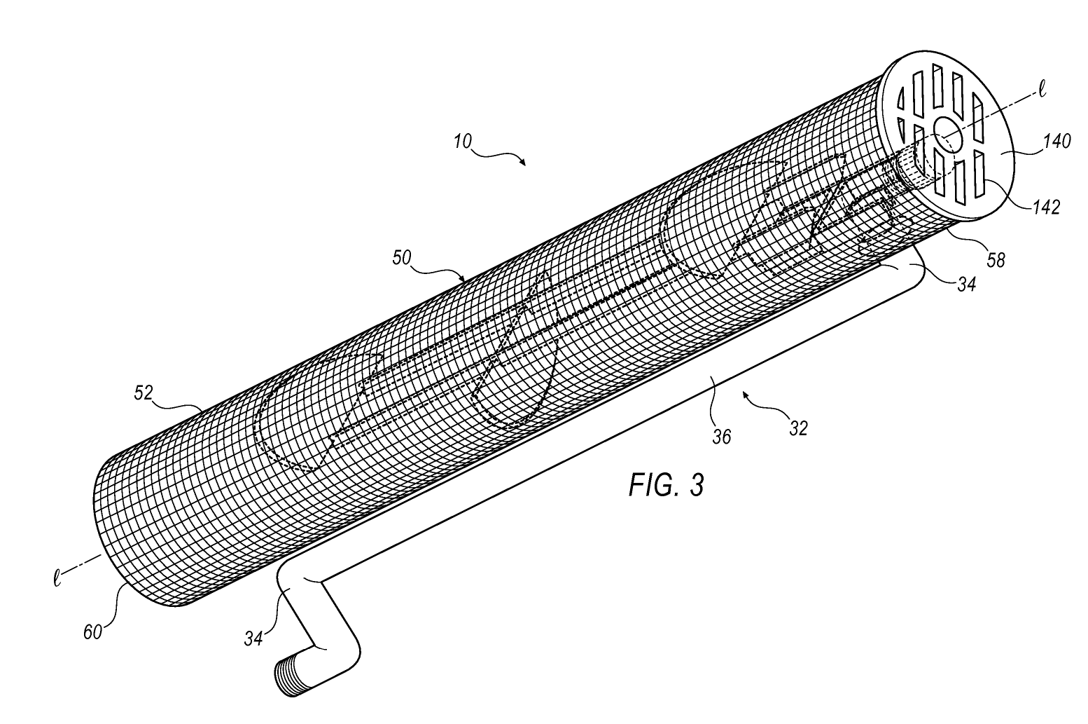

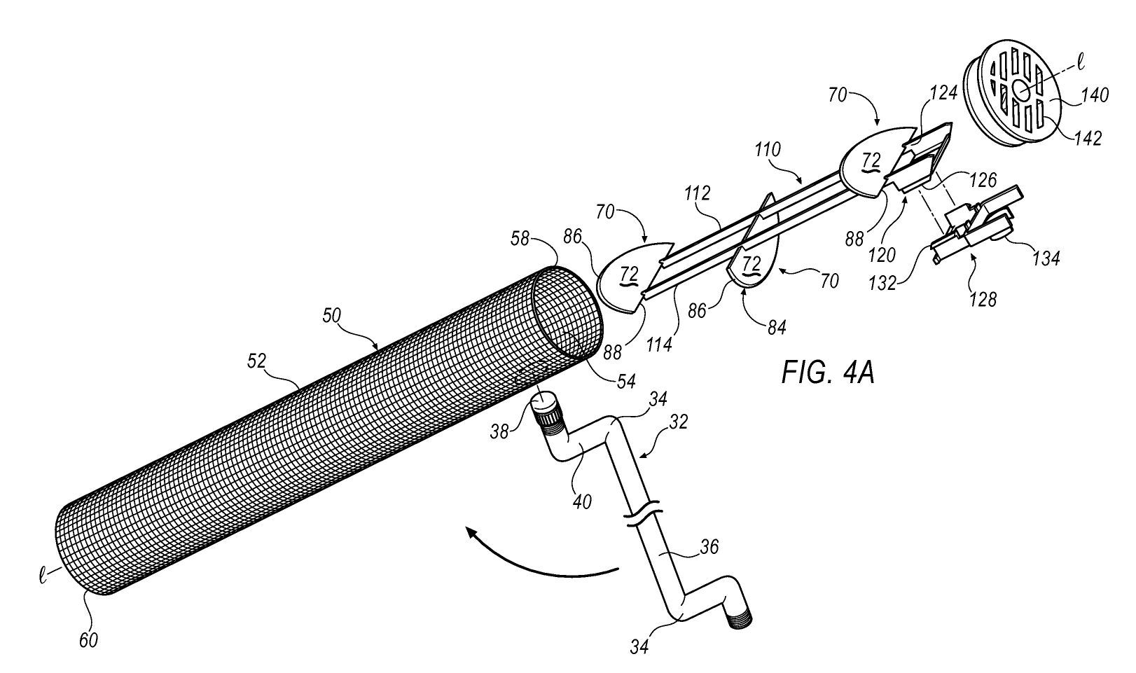

FIGS. 2-4b illustrate an exemplary irrigation device 10 with a housing 50 having a substantially cylindrical shape. The housing 50 includes a sidewall 52 that defines and encloses an internal cavity 54. The sidewall 52 should be of a sufficient porosity to allow water 42 to readily pass from the internal cavity 54 to soil 12 surrounding the housing 50. A thin mesh material allowing water 42 and nutrients to exit the cavity 54 while preventing excessive migration of soil 12 and roots 18, 20, 22 into the device is ideally suited for the sidewall 52. A semi-rigid sidewall 52 can maintain a general shape while flexing around minor imperfections and intrusions in the surrounding soil 12. In areas with very loose or sandy soil 12, an optional fibrous wrapping (now shown) can be wrapped around the outer surface of the sidewall 52. Such a fibrous barrier can prevent the penetration of excessive amounts of soil 12 into the housing 50 while not materially effecting the passage of water 42 out of the device. Choosing a durable material for the sidewall 52, such as a polymer capable of prolonged exposure to water and soil, can allow for the device to operate effectively over a length of time. An access hole 56 in the sidewall 52 can accept a water feed line 32. Alternatively, the water feed line 32 can enter from an upper 58 or lower end 60 of the housing.

The internal cavity 54 of the housing 50 provides a space for a plurality of deflectors 70. Deflectors 70 catch falling water 42 (from sources both within and without the housing) and collect the same against the sidewall 52. In this regard the deflectors 70 provide a deflecting surface 72 to form a collection basin 74 in cooperation with an adjacent portion of the sidewall 76. Deflectors 70 are angled downwardly with respect to a central area 78 of the internal cavity 54 such that a lower portion 80 of the deflector abuts the sidewall 52 at the base 82 of the collection basin 74. A unitary deflecting surface 72 extends upwardly from the lower portion 80 and is sloped toward the center 78 of the internal cavity 54. Deflectors 70 having various shapes can be used to create a collection basin 74. Each deflector can have a shape corresponding, at least in part, to an oblique cross-section of the sidewall. In the exemplary embodiment of FIG. 2 where the housing 50 is substantially cylindrical, the deflectors 70 can have a semi-oval shape with a unitary deflecting surface 72.

At least a potion of the perimeter 84 of the deflectors 70 abuts the sidewall 52. Absent integrally forming or otherwise sealing the deflectors 70 to the sidewall 52, water leakage out of the base 82 of the collection basin 74 can occur. To partially address this potential for water leakage, the perimeter edge 84 along of the deflector is sheared 86 to correspond with the inner surface of the sidewall. Such a shear 86 can reduce the amount of water 42 that leaks between the sidewall 52 and the perimeter edge 84 of the deflectors 70 by providing a greater amount of contact between the deflectors 70 and the sidewall 52. An upper end 88 of the deflecting surface 72 does not abut the sidewall 52 and thereby provides a water flow path 90 between the upper end 88 and a portion 92 of the sidewall opposing the collection basin 74. Water 42 accumulates in the collection basin 74 for a period of time until the water level breaches the upper end 88 and spills out into the flow path 90.

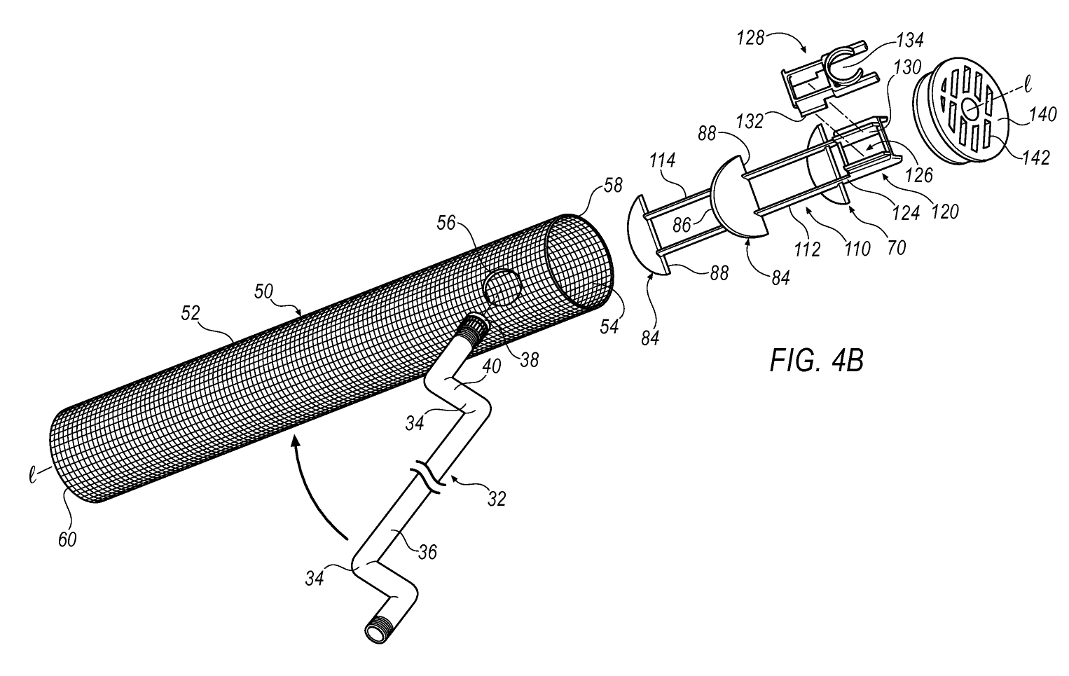

FIG. 5 provides details of the relationship between the various deflectors of a device. When a deflector 100 is arranged with one or more other lower deflectors 102,104, water flow paths 90, 91 are positioned above the deflecting surfaces 103,105 of lower deflectors 102,104. In this laterally offset arrangement of the deflectors 100,102,104, there is a reduced possibility that water could enter the upper end 58 of the device 10 and reach the lower end 60 of the device without coming against at least one of the deflecting surfaces 101,103,105. The arrangement of the deflectors alters the direction of any water that exits the housing. Deflectors can be arranged in varying radial directions in order to direct water out of the housing 50 in a corresponding direction. The radial direction is generally defined with respect to the longitudinal axis l of the housing 50 and the point 106 where the lowermost portion 108 of a deflector 100 abuts the sidewall 52. Accordingly, if it were desirable to direct water 42 out of the housing 50 in roughly a single radial direction, the deflectors could be positioned in vertically stacked parallel planes. In such an arrangement, the deflecting surfaces could increase in size at each lower level in order deflect any water falling from an above-positioned flow path. Assuming the deflectors only partially span the internal cavity and thereby provide a flow path 90, 91 to a lower deflector 102,104, each additional radial direction increases the number of deflectors required to block all straight line paths from the upper end 58 to lower end 60 of the housing. An alternative to radially positioning multiple deflectors about the longitudinal axis l would be in increase the size of the deflecting surface. Deflecting surfaces that fully obstruct the flow path of water from an upper end of the housing to a lower end are discussed below.

A support structure 110 extends between and supports the deflectors 100,102,104. The support structure can have one or more support elements 112,114 extending between the deflectors. In the exemplary embodiment the support elements 112,114 extend longitudinally within the housing 50 and are positioned parallel to the longitudinal axis l. An upper edge 116 of each deflector attaches to the support elements 112,114 of the support structure 110. The deflectors 100,102,103 and support elements 112,114 can be separate elements that attach together at the time of installation, or as depicted can be an integrally molded unitary element 118. Providing deflectors and support elements that attached together as a unitary element 118 can ease the assembly of the device. Similarly, a unitary collection 118 of deflectors and support elements could simplify disassembly should the device 10 ever need to be disassembled for removal or maintenance reasons.

Alternative support structures could replace a central support with a series of support elements that link each deflector to only the immediately preceding or following deflector (if such a deflector exists). Similarly a lattice of support elements could interconnect the deflectors. Support structures can vary the number and type of support elements in relation to the degree of rigidity required. While a semi-rigid sidewall might only require minimal reinforcement from the deflectors and support structure, more pliable sidewall materials could benefit from a more robust and rigid support structure. Attaching one or both ends of the support structure to a respective upper or lower end of the housing could add additional rigidity. Finally, the deflectors could be attached directly to each other in order to form a self-supporting support structure.

A mast 120 positioned above the uppermost deflector 100 can be configured to connect to an end 40 of the water feed line 32 or another element within the internal cavity 54. The mast 120 can be an upper end 124 of the support structure 110 or can be a separate element that is attached to the uppermost deflector 100. For added flexibility the mast 120 includes a receptor 126 for a mating element 128. A square receiving socket 130 receives the locking tabs 132 of a correspondingly shaped mating element 128. Various mating elements 128 corresponding to different types of water feed lines 32 can be removably attached to the receptor 126. In the depicted embodiment, the mating element 128 includes a well 134 that partially encloses the end 40 of the water feed line 32 with a snap-fit attachment. As should be apparent to one skilled in the art, other attachment methods including screw threads, and integral attachment could be equally suitable. Similarly, the mating element 128 could be designed to attach to the sidewall 52, an upper cap 140, or any other element within the internal cavity 54 of the housing 50.

An optional cap 140, which may include perforations or slots 142, may be employed to close off the open top 58 of the housing 50 to prevent debris and other objects from falling into the central cavity 54. Alternatively, the cap could be formed of a mesh or screen-like material. Similarly, a lower cap (not shown) can be coupled to the housing 50 at an end 60 opposite the upper cap 140. Both the upper 140 and lower caps further reinforce the sidewall 52 of the housing 50. An impermeable lower cap can prevent the loss of water out the lower end 60 of the device 10. In situations where it is desirable for excess water to exit the lower end 60 of the device 10, the lower cap can be omitted.

In an installed configuration, the housing would be buried in a vertical orientation proximate to a root system of a plant and a water main. One end of the water feed line taps the water main while a second end passes through the housing and into the internal cavity where it would be attached to the mating element. The mating element would be attached to the upper end of the support structure. The plurality of deflectors would be supported by the one or more support elements of the support structure. Water would exit the water feed line through the emitter and pass downwardly onto the first and second deflectors. As the water accumulates in the collection basins of the first and second deflectors, a portion of it would fall over the respective upper ends of the deflection surfaces onto lower deflectors.

Alternative Embodiment with Integrated Water Pipe

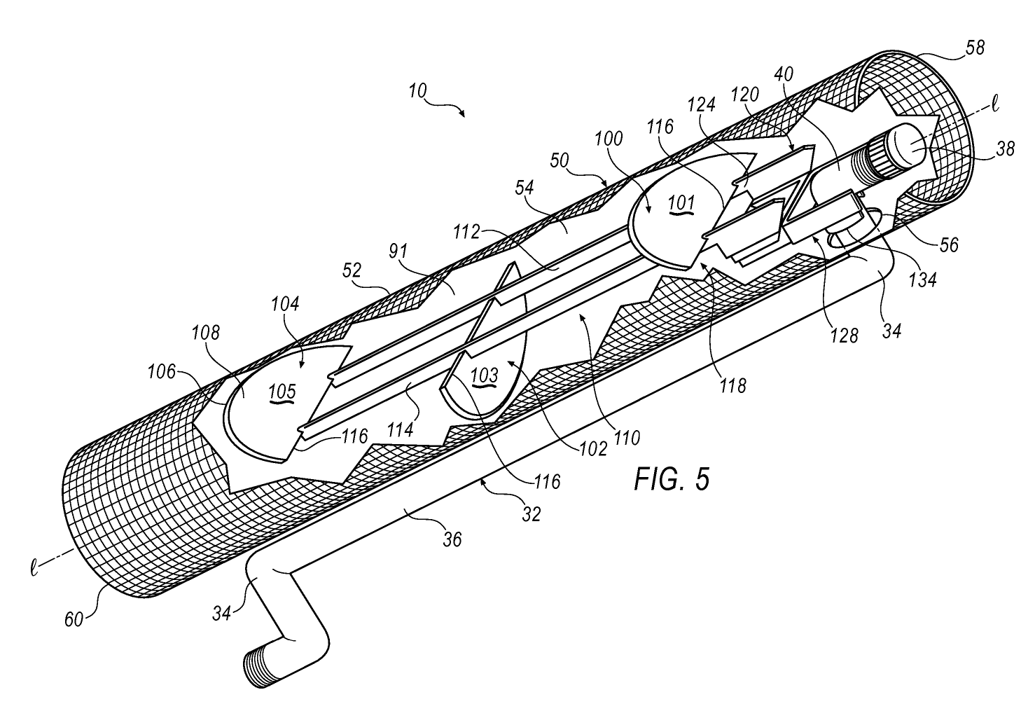

FIG. 6 illustrates an exemplary support structure 150 for an irrigation device 10 that includes an integrated pipe 152. The pipe 152 is configured to transport water from a point outside of the housing to at least one point 154 within the housing 50. Similar to the support structure 110 above, the integrated pipe support structure 150 is configured to be inserted into the housing 50. The pipe 152 would extend along the longitudinal axis t of the housing 50 once installed. A plurality of deflectors 156 attach to the support structure 150 by any of a number of attachment means including integral attachment. The deflectors 156 are interconnected to each other by way of the water pipe 152. The lower end 158 of the pipe 152 includes a fitting 160 to attach to a water feed line 162. The threaded fitting 160 allows the support structure 150 and attached deflectors 156 to be removably attached to the water feed line 162. In this configuration, the pipe 152 and deflectors 156 can be removed should the device ever require maintenance such as debris removal. As depicted the water feed line 162 could enter the housing 50 through a lower cap 164. Alternatively, the water feed line could enter the housing through an opening near a lower end of the sidewall.

As depicted the water pipe 152 can include an emitter 166 at an upper end 168 to regulate the flow and spray pattern of the emitted water. In this configuration, water exits the pipe 152 through the emitter 166 and falls on to a first 170 and second deflector 172. As the water continues to collect, the pooled water will eventually top the upper edge 171,173 of the deflecting surfaces 170′, 172′ and descend to a lower deflector 178. Accordingly, this configuration favors roots in an upper region of the soil as compared to roots at a lower level. Alternatively, water emitting orifices could be disposed along the length of the pipe to supply water to the various deflectors all at the same time. In such an alternative configuration, roots at all levels could be watered equally. A single unitary element 150 comprising the water pipe 152 and deflectors 76 has the advantage of being simple to install and remove as necessary.

Alternative Embodiment with Full Deflectors, Orifices, Small Diameter Tube

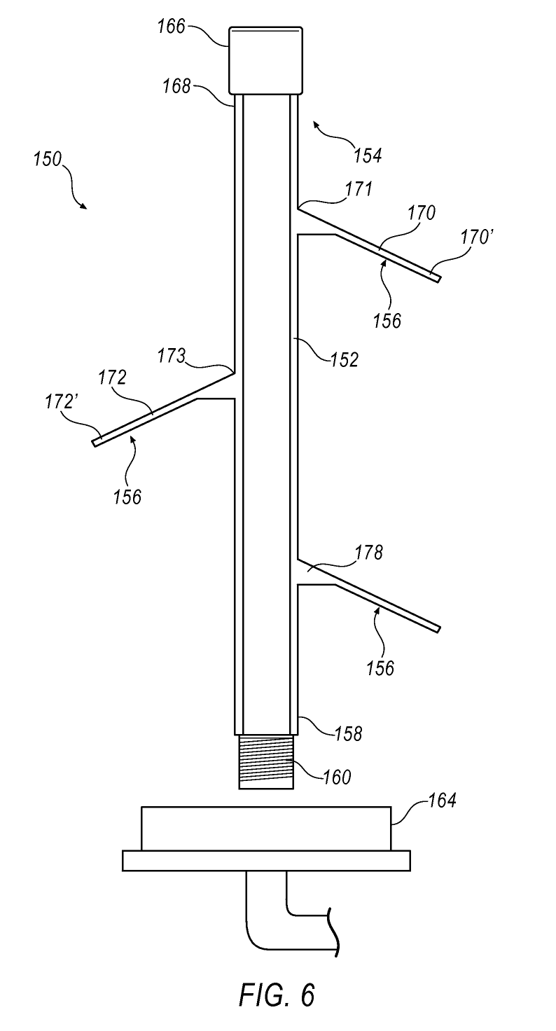

FIG. 7 illustrates an additional exemplary embodiment of a root irrigation device 10 including deflectors 180 that fully span the internal cavity of the housing. While the deflectors above cooperate to span the internal cavity 182 of the housing 184, the deflectors 180 of this embodiment each individually span the internal cavity 182. Each deflector has a single flat deflecting surface 186. Other possible deflecting surfaces will be discussed below. Given the cylindrical shape of the housing, the deflecting surface of each deflector has an oval perimeter. The deflecting surface 186 of the deflectors extends from the lower end 188 of the deflector abutting a first point 190 of the sidewall 185 to the upper end 192 of the deflector abutting a second point 194 of the sidewall 185, which opposes the first point 190. In this arrangement, substantially the entire perimeter of the deflecting surface abuts some portion of the sidewall 185. Deflectors 186 with perimeters substantially abutting the sidewall 185 provide lateral support thereto.

The angle between the sidewall and the deflecting surface relates to the volume of water that can accumulate in the collection basin. Assuming the angle between the deflecting surface and the sidewall is the same as in previous embodiments, a larger volume of water can accumulate in the collection basin 196 formed between the deflecting surface 186 and an adjacent portion 198 of the sidewall in this embodiment. A large volume collection basin 196 has some notable properties. First the greater volume exerts a greater force on the water at the base of the collection basin which can result in greater penetration of water into the surrounding soil. However, a larger collection basin requires a greater amount of time to fill absent an increased water emission rate. Accordingly, it will take a greater amount of time for water to reach a lower deflector. This has the effect of favoring roots closer to ground level. Such favoritism can be countered by watering for a sufficiently long period of time to allow for water to reach any lower deflectors. Additionally, the depicted deflectors provide less directionality to the water that exits the housing. Because the collection basin extends around the full perimeter of the housing, water exits the housing in all directions. Alternative deflector designs discussed below can address directionality.

The deflecting surface no longer has the upper edge (as depicted in FIG. 2) for water to spill over. Accordingly, one or more orifices 200,202 are included with the deflector. The orifices permit water that has accumulated within the collection basin 196 to pass down to the next deflector. In the depicted embodiment, two orifices are included in a vertically staggered arrangement. The lower orifice 200 may be larger than the upper orifice 202. Water passes from the collection basin 196 through the lower orifice 200 while air passes from the lower collection basin to the upper collection basin through the upper orifice 202. Including the second orifice 202 for the transmission of air equalizes the air pressure and allows for an improved flow of water between the collection basins.

The deflectors are arranged with a self-supporting support structure. A lower end 188 of a deflector attaches and upper end 192 of the next lower deflector. Such a configuration of interconnected deflectors provides increased rigidity to each deflector. Additionally, the interconnected deflectors can be installed and removed from the housing as a unitary element. Alternatively, a support structure including one or more support elements as in FIG. 2 could be equally effective. In some situations it may be desirable to omit any support structure. An opening in the sidewall can accept a water emitter. U.S. application Ser. No. 11/073,491 entitled “COMBINATION WATERING AND AERATING UNIT” discloses an exemplary emitter that could be used with the device. An anchor element 210 at the base 212 of the housing can facilitate the insertion of the device into the ground by providing a ground penetrating edge 214. Additionally the anchor element can anchor the device into the soil with one or more anchoring surfaces 216.

Alternative Deflector Shape, Pyramidal, Conical

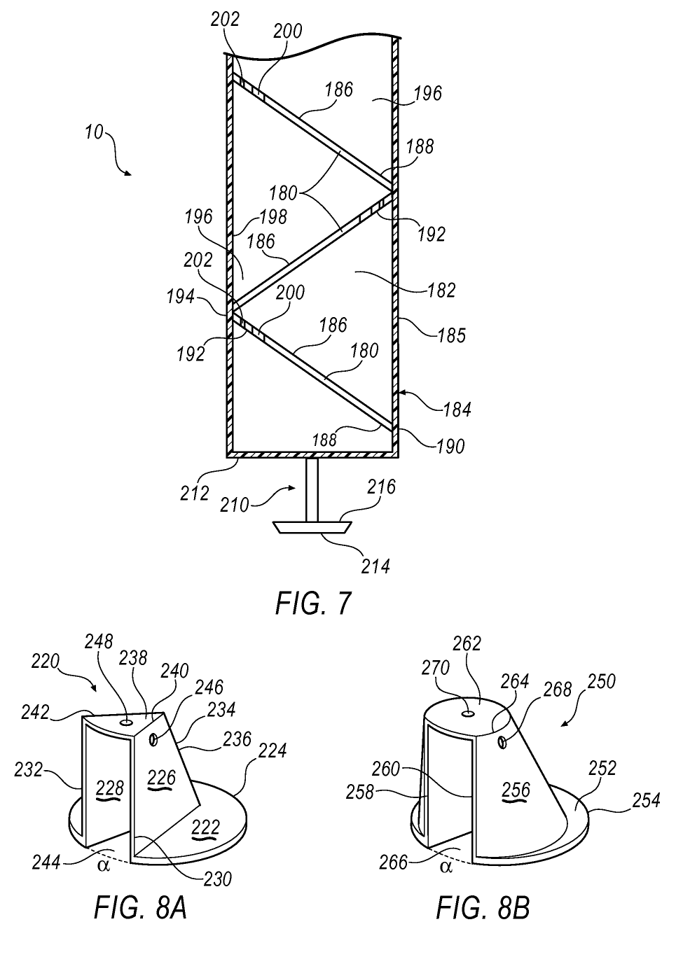

Deflectors having any number of shapes could be equally effective in slowing the flow of water from an upper potion of the device to a lower portion of the device. Varying the deflector shape can affect the directionality of water passing through the housing. With reference to FIG. 8a, an exemplary embodiment of one such alternative deflector 220 design is presented. This deflector 220 includes a base 222 that abuts the wall member at a first lower point 224 and extends generally perpendicular to the wall member. Two deflecting surfaces 226,228 extend vertically from the horizontal base 222. Edges 230,232 of each deflecting surface 226,228 abuts the wall member while opposing edges 234,236 are joined together. An upper surface 238 joins the upper edges 240,242 of the deflecting surface 226,228 as well as the wall member. The deflecting surfaces 226,228 and the upper surface 238 enclose a void 244. As disclosed above the deflector subdivides the internal cavity of the housing in to discrete portions. The inclusion of one or more orifices 246,248 allows water and air to flow between the discrete portions.

With reference to FIG. 8b, an exemplary embodiment of another alternative deflector 250 design is presented. This deflector 250 includes a base 252 that abuts the wall member at a first lower point 254 and extends generally perpendicular to the wall member. A continuous curved deflecting surface 256 extends vertically from horizontal base. A first and second side edge 258,260 of the deflecting surface abuts the wall member. An upper surface 262 attaches between an upper edge 264 of the deflecting surface and the sidewall. The deflecting surface 256 and the upper surface 262 enclose a void 266. As disclosed above the inclusion of one or more orifices 268,270 allows water and air to flow between the subdivided internal cavity.

The exemplary deflectors 220,250 presented in FIGS. 7a and 7b can be attached to the sidewall of the housing, or can be interconnected with other deflectors to form a support structure. The support structure as in FIG. 2 including one or more support elements or the self-supporting support structure as in FIG. 6 could both be equally effective in interconnecting the deflectors. As discussed above, deflectors can be arranged to direct water out various radial directions of the housing. The shape of the deflector influences the degree of directionality provided. Specifically, the size of the void 244,266 as determined by the spacing a of the vertical edges 230,232 and 258,260 of the deflecting surface alters the degree of directionality. A larger void 244,266 created by a larger arc length a between the vertical edges 230,232 and 258,260 of the deflecting surfaces increases the directionality by reducing the area that water can exit the sidewall.

The preceding description has been presented only to illustrate and describe exemplary embodiments of the claimed invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

I claim:

1. An irrigation device, comprising:
a porous housing; and,
a plurality of interconnected deflectors disposed within said housing and configured to direct water through said housing to areas surrounding said device.

2. The irrigation device of claim 1, further comprising:
a wall member forming an external surface of said housing; and, an internal cavity enclosed by said wall member, said interconnected deflectors laterally spanning said internal cavity.

3. The irrigation device of claim 1, further comprising a support structure, said interconnected deflectors interconnected by said support structure.

4. The irrigation device of claim 3, wherein said support structure comprising at least one support element, said at least one support element extending between one or more deflectors of said plurality of interconnected deflectors.

5. The irrigation device of claim 3, wherein said support structure centrally disposed with said housing.

6. The irrigation device of claim 3, further comprising a water feed line adjacent to said support structure.

7. The irrigation device of claim 3, wherein each deflector of said plurality of interconnected deflectors comprising an upper end supported by said support structure and a lower end abutting said wall member.

8. The irrigation device of claim 1, further comprising a tube adapted to transport water disposed within said housing, said interconnected deflectors interconnected by said tube.

9. The irrigation device of claim 1, wherein each deflector of said plurality of interconnected deflectors comprising a unitary surface.

10. The irrigation device of claim 9, wherein said unitary surface having the shape of an oblique cross-section of said housing.

11. The irrigation device of claim 1, further comprising a water feed line extending into said housing, said plurality of interconnected deflectors supported by said water feed line.

12. The irrigation device of claim 1, wherein each deflector of said plurality of interconnected deflectors lies in a first plane that intersects a plane of at least one other deflector of the plurality of interconnected deflectors.

13. The irrigation device of claim 1, further comprising:
a mating element removably attached to said plurality of interconnected deflectors; and
an internal element disposed within said housing, said mating element removeably attached to said internal element.

14. The irrigation device of claim 13 further comprising a water feed line extending into said housing, said internal element comprising a portion of said water feed line.

15. The irrigation device of claim 13, further comprising a covering attached to an end of said housing, said internal element comprising a portion of said covering.

16. The irrigation device of claim 1, wherein said plurality of interconnected deflectors including a first deflector and at least one lower deflector, said lower deflector positioned below a preceding deflector such that said upper end of said lower deflector attached to said lower end of said preceding deflector.

17. An irrigation device, comprising:
a mesh tube configured to distribute water to surrounding soil; and,
at least one deflector disposed within said tube, said deflector comprising at least one deflecting surface and at least one orifice, said deflector configured to collect an amount of water between said deflecting surface and said housing, the volume of said amount of water partially constrained by said orifice.

18 The irrigation device of claim 17, wherein said at least one orifice comprising at least two orifices in a vertically staggered arrangement.

19. The irrigation device of claim 17, wherein said at least one deflecting surface comprising a plurality of deflecting surfaces arranged in a pyramidal configuration.

20. The irrigation device of claim 17, wherein said at least one deflecting surface comprising a plurality of deflecting surfaces arranged in a conical configuration.

21. The irrigation device of claim 17, wherein said at least one deflector comprising a plurality of interconnected deflectors.

22. The irrigation device of claim 17, wherein substantially every point of a perimeter of said deflector abutting a portion of said wall member

23. An irrigation device, comprising:
an elongated hollow housing configured to be buried in the ground in a generally vertical orientation proximate to a root system of a plant, said housing including a porous exterior wall member enclosing an internal cavity, said housing configured to distribute water within said internal cavity though said wall member to areas surrounding said device; and,
a framework disposed within said housing and spanning said internal cavity, said framework comprising a plurality of deflectors configured to deflect water through said wall member.

24. The irrigation device of claim 23, wherein said framework abutting a plurality of points of said wall member and configured to provide lateral support thereto.

25. The irrigation device of claim 23, wherein said framework comprising one or more components configured to be removably inserted into said housing as a unitary element.

26. The irrigation device of claim 23 wherein said plurality of deflectors cooperate to block any straight line path between an tipper end of said housing and a lower end of said housing.
